(19) United States
(12) Patent Application Publication
(10) Pub. No.: US 2024/0372208 A1
(43) Pub. Date: Nov. 7, 2024

(54) BATTERY PACK AND VEHICLE INCLUDING THE SAME

(71) Applicant: LG ENERGY SOLUTION, LTD., Seoul (KR)

(72) Inventors: Sung-Hwan Jang, Daejeon (KR); Jun-Yeob SEONG, Daejeon (KR)

(73) Assignee: LG ENERGY SOLUTION, LTD., Seoul (KR)

(21) Appl. No.: 18/774,228

(22) Filed: Jul. 16, 2024

Related U.S. Application Data
(63) Continuation of application No. PCT/KR2023/005989, filed on May 2, 2023.

(30) Foreign Application Priority Data
May 16, 2022 (KR) 10-2022-0059601

(51) Int. Cl. H01M 50/333; B60L 50/64; H01M 50/211; H01M 50/383

(52) U.S. Cl. CPC H01M 50/333; B60L 50/64; H01M 50/211; H01M 50/383; H01M 2220/20

(57) ABSTRACT

The battery pack includes a battery module, and a pack housing accommodating the battery module in a module receiving portion, and including an opening/closing member configured to vent a venting gas or flame out of the module receiving portion in an event of thermal runaway in the battery module.

The present application is a continuation of PCT/KR2023/005989, filed May 2, 2023, and claims priority to Korean Patent Application No. 10-2022-0059601 filed on May 16, 2022 in the Republic of Korea, the disclosure of which is incorporated herein by reference.

### TECHNICAL FIELD

The present disclosure relates to a battery pack and a vehicle including the same, and more particularly, to a battery pack configured to ensure structural stability in case of a thermal event and a vehicle including the same.

### BACKGROUND ART

Recently, there has been a rapid increase in the demand for portable electronic products such as laptop computers, video cameras and mobile phones, and with the development of electric vehicles, accumulators for energy storage, robots and satellites, many studies are being made on high performance secondary batteries that can be repeatedly recharged.

Currently, commercially available secondary batteries include nickel-cadmium batteries, nickel-hydrogen batteries, nickel-zinc batteries, lithium secondary batteries and the like. Among them, lithium secondary batteries have little or no memory effect, and thus they are gaining more attention than nickel-based secondary batteries for their advantages that recharging can be done whenever it is convenient, the self-discharge rate is very low and the energy density is high.

Lithium secondary batteries primarily comprise lithium-based oxides and carbon materials for a positive electrode active material and a negative electrode active material, respectively. Additionally, lithium secondary batteries comprise an electrode assembly including a positive electrode plate and a negative electrode plate coated with the positive electrode active material and the negative electrode active material, respectively, with a separator interposed between the positive electrode plate and the negative electrode plate and an outer packaging or a battery case accommodating the electrode assembly together with an electrolyte solution.

Meanwhile, lithium secondary batteries can be classified into can-type secondary batteries in which the electrode case is included in a metal can and pouch-type secondary batteries in which the electrode assembly is included in a pouch of an aluminum laminate sheet according to the shape of the battery case. Additionally, the can-type secondary batteries can be sub-classified into cylindrical batteries and prismatic batteries according to the shape of the metal can.

Here, the pouch of the pouch-type secondary batteries can largely include a lower sheet and an upper sheet disposed on the lower sheet. In this instance, the electrode assembly including the positive electrode, the negative electrode and the separator stacked and wound is received in the pouch. Additionally, after the electrode assembly is received, the upper sheet and the lower sheet are sealed along the edges by heat welding. Additionally, an electrode tab extended from each electrode can be coupled to an electrode lead, and an insulating film can be attached to an area of contact between the electrode lead and the sealing portion.

The pouch-type secondary batteries can have flexibility to form various shapes. Additionally, the pouch-type secondary batteries can realize secondary batteries of the same capacity with smaller volume and mass.

To provide high voltage and high current, the secondary batteries are used to manufacture a battery module or a battery pack by stacking or piling up a plurality of battery cells with or without mounting in a cartridge to form a closely packed structure, and electrically connecting them.

In the above-described battery pack configuration, one of the important issues is safety. In particular, in case where a thermal event occurs in the battery module, high temperature and high pressure venting gas can occur in the battery module, and when the venting gas meets oxygen, flame can occur inside or outside of the battery module.

Additionally, when a thermal event occurs in any of the battery modules included in the battery pack, it is necessary to suppress the propagation of the event to the other battery module. Unless thermal propagation between the battery modules is successfully suppressed, it can lead to a thermal event in the other battery module included in the battery pack, causing a more serious problem such as a fire or explosion in the battery pack. Further, the fire or explosion in the battery pack can cause loss of lives or economic damage. Accordingly, the battery pack requires configuration for properly controlling the thermal event.

### DISCLOSURE

### Technical Problem

The present disclosure is designed to solve the above-described problem, and therefore the present disclosure is directed to providing a battery pack configured to ensure structural stability in case of a thermal event and a vehicle including the same.

The technical problem to be solved by the present disclosure is not limited to the above-described problems, and these and other problems will be clearly understood by those skilled in the art from the following description.

### Technical Solution

To achieve the above-described objective, a battery pack according to an aspect of the present disclosure includes at least one battery module, and a pack housing accommodating the at least one battery module in at least one module receiving portion, the at least one module receiving portion including an opening/closing member configured to vent a venting gas or flame out of the at least one module receiving portion in an event of thermal runaway in the at least one battery module.

Preferably, the pack housing includes a side frame which forms a side of the pack housing, and at least a portion of the side frame facing the opening/closing member, a flow path between the at least one module receiving portion and the side frame, and formed in communication with the at least one module receiving portion through a circulation hole in the at least one module receiving portion, and an exit port disposed in the side frame, the exit port communicating with the flow path and configured to vent the venting gas or flame out of the pack housing.

Preferably, the opening/closing member can be configured such that a first end contacts the side frame when opened.

Preferably, the opening/closing member can be configured to be open at an acute angle with respect to a partition of the at least one module receiving portion.

Preferably, the exit port can be formed at a location in the side frame relative to the opening/closing member so that the flow path bends on or more times.

Preferably, the at least one battery module is a plurality of the battery modules, and the at least one module receiving portions is a plurality of the module receiving portions, each of the plurality of the battery modules can be received in a respective one of the plurality of module receiving portions, and each of the plurality of module receiving portions can be configured to be air-tightly closed by a partition.

Preferably, each opening/closing member corresponding to each module receiving portion of the plurality of module receiving portions can be disposed in the partition.

Preferably, each opening/closing member can be configured to be open at an acute angle with respect to the partition, and at least one opening/closing member can be configured to reduce an opening angle toward the exit port.

Preferably, an opening/closing member located furthest away from the exit port can be configured such that a first end contacts the side frame when opened.

Preferably, at least one of the opening/closing members can have a shorter length than another opening/closing member further from the exit port.

Preferably, an interrupt member configured to prevent the flame can be disposed on an outer surface of each opening/closing member.

Preferably, the battery pack can further include a guide member at a corner of the side frame, and configured to guide the venting gas or flame towards the exit port.

Preferably, the battery pack can further include a mesh member disposed in the exit port, and configured to filter out the flame and allow the venting gas to pass through.

Additionally, a vehicle according to another aspect of the present disclosure includes least one battery pack according to an aspect of the present disclosure as described above.

A pack housing can include a side frame forming an exterior surface, a partition in the side frame, the partition forming at least one battery module receiving area and a firstflow path between the partition and a first side of the side frame, at least one circulation hole formed in the partition allowing communication between the at least one battery module receiving area and the first flow path, at least one opening/closing member covering the at least one circulation hole and a first exit port in the side frame.

The first exit port can be in a second side of the side frame.

A second flow path can be between the partition and a third side of the side frame, wherein the partition extends across the side frame from a second side of the side frame to a fourth side of the side frame to separate the first flow path from the second flow path, and wherein the second flow path has a second exit port.

The at least one battery module receiving area can be a plurality of battery module receiving areas formed by the partition, the at least one circulation hole can be a plurality of circulation holes respectively formed in the plurality of battery module receiving areas, and the at least opening/closing member can be a plurality of opening/closing member respectively covering each of the plurality of circulation holes.

A protrusion can extend from the partition, the protrusion can restrict an opening angle of the at least one opening/closing member.

The at least one opening/closing member can have a first opening/closing member and a second opening/closing member, the first opening/closing member being further from the first exit port than the second opening/closing member, and the first opening/closing member can contact the first side of the side frame when fully opened and the second opening/closing member can be spaced from the first side of the side frame when fully opened.

### Advantageous Effects

According to an aspect of the present disclosure, it can be possible to achieve the rapid venting of venting gas and/or flame through the opening/closing member, thereby suppressing the cause of fire in the battery module and enhancing structural stability of the battery pack.

Additionally, it can be possible to prevent venting gas and/or flame from staying in the pack housing, and guide the venting of venting gas and/or flame out of the pack housing more effectively.

Additionally, when thermal runaway simultaneously occurs in the plurality of battery modules, it can be possible to prevent restriction of the flows of venting gas and/or flame vented to the flow path through the opening up of each opening/closing member towards the exit port, and effectively prevent backflow of venting gas and/or flame into the plurality of module receiving portions.

Many other additional effects can be achieved by many other aspects of the present disclosure. These effects of the present disclosure will be described in detail in each aspect, or description of effects that can be easily understood by those skilled in the art is omitted.

### DESCRIPTION OF DRAWINGS

The accompanying drawings illustrate exemplary aspects of the present disclosure and together with the following detailed description, serve to provide a further understanding of the technical aspect of the present disclosure, and thus the present disclosure should not be construed as being limited to the drawings.

FIG. 1 is a diagram showing a battery pack according to an aspect of the present disclosure.

FIG. 2 is a diagram illustrating the detailed structure of the battery pack of FIG. 1.

FIG. 3 is a diagram showing a battery module of the battery pack of FIG. 2.

FIG. 4 is an enlarged diagram of section A in FIG. 2.

FIG. 5 is a diagram showing an opening/closing member in open state in FIG. 4.

FIGS. 6 and 7 are diagrams showing an example of venting of venting gas or flame in the event of thermal runaway in a battery module.

FIGS. 8 and 9 are diagrams showing another example of venting of venting gas or flame in the event of thermal runaway in a battery module.

FIG. 10 is a diagram showing a battery pack according to another aspect of the present disclosure.

FIG. 11 is a diagram showing a battery pack according to another aspect of the present disclosure.

FIG. 12 is a diagram showing a battery pack according to another aspect of the present disclosure.

FIG. 13 is a diagram showing a battery pack according to another aspect of the present disclosure.

FIG. 14 is a diagram showing a battery pack according to another aspect of the present disclosure.

FIG. 15 is a diagram showing a battery pack according to another aspect of the present disclosure.

FIGS. 16 and 17 are diagrams showing a battery pack according to another aspect of the present disclosure.

### BEST MODE

Hereinafter, exemplary aspects of the present disclosure will be described in detail with reference to the accompanying drawings. Prior to the description, it should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

Therefore, the aspects described herein and illustrations in the accompanying drawings are an exemplary aspect of the present disclosure to describe the technical aspect of the present disclosure and are not intended to be limiting, and thus it should be understood that a variety of other equivalents and modifications could have been made thereto at the time that the application was filed.

Additionally, the present disclosure includes many different aspects. In the description of substantially identical or similar components for each aspect, redundant description is omitted and difference(s) is described.

The terms indicating directions such as upper, lower, left, right, front and rear are used for convenience of description, and it is obvious to those skilled in the art that the terms can change depending on the position of the stated element or an observer.

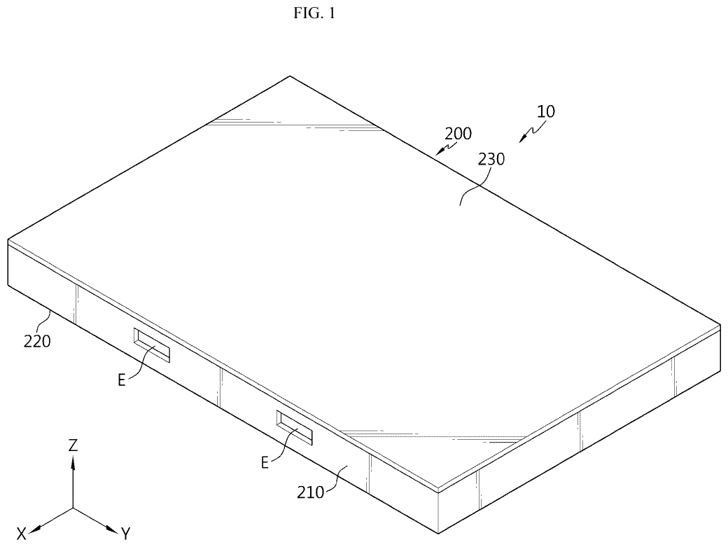

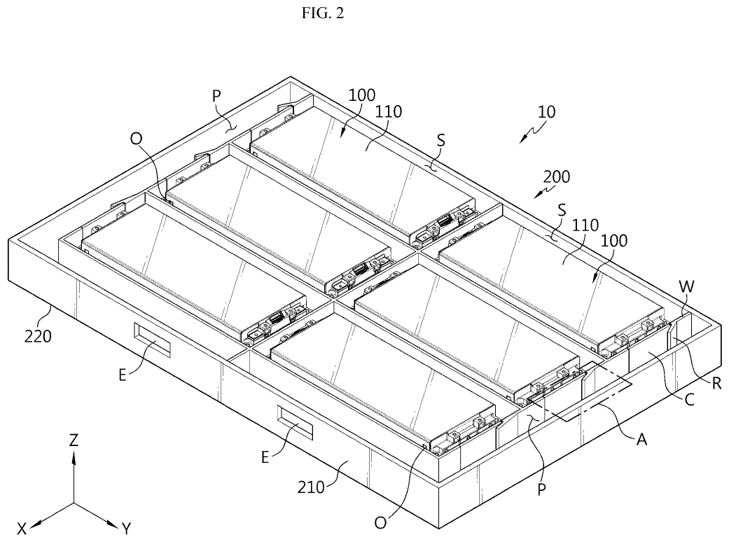

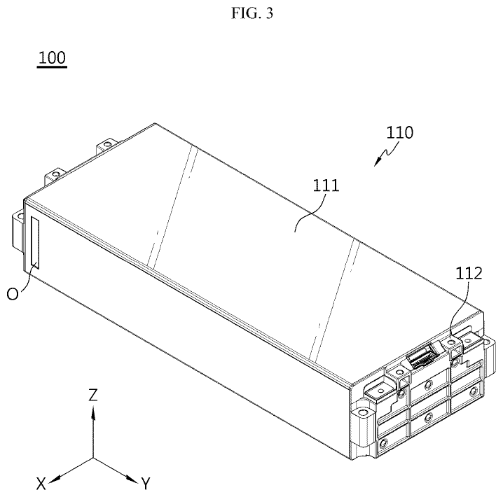

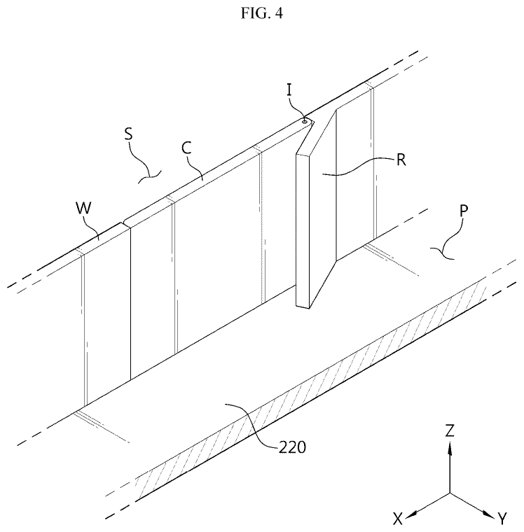

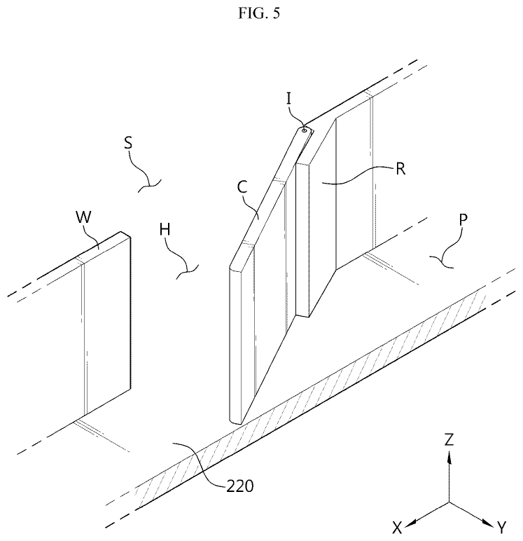

FIG. 1 is a diagram showing a battery pack 10 according to an aspect of the present disclosure, FIG. 2 is a diagram illustrating the detailed structure of the battery pack 10 of FIG. 1, FIG. 3 is a diagram showing a battery module 100 of the battery pack 10 of FIG. 2, FIG. 4 is an enlarged diagram of section A in FIG. 2, and FIG. 5 is a diagram showing an opening/closing member C in open state in FIG. 4. In this instance, in FIG. 2, illustration of a top cover 230 as described below is omitted.

In an aspect of the present disclosure, the X axis direction shown in the diagrams can refer to a front-rear direction, the Y axis direction can refer to a left-right direction perpendicular to the X axis direction on the horizontal plane (XY plane), and the Z axis direction can refer to an up-down direction perpendicular to the X axis direction and Y axis direction.

Referring to FIGS. 1 to 5, the battery pack 10 according to an aspect of the present disclosure can include a battery module 100 and a pack housing 200.

The battery module 100 can include a cell assembly (not shown) and a module case 110.

The cell assembly can include at least one battery cell. Here, the battery cell can refer to a secondary battery. The battery cell can include a pouch type battery cell, a cylindrical battery cell or a prismatic battery cell. In an example, the battery cell can be a pouch type battery cell.

The module case 110 can accommodate the cell assembly. To this end, the module case 110 can have an internal receiving space for receiving the cell assembly inside.

Additionally, the module case 110 can include a case body 111 accommodating the cell assembly and having open ends at two sides and an end plate 112 coupled to the two sides of the case body 111, as seen in FIG. 3. The case body 111 can be formed in the shape of a pipe having two open ends, and the end plates 112 can be coupled to the two open ends of the case body 111. Referring to FIG. 3, the end plates 112 can face each other along the Y axis. The end plates 112 can be coupled to the open ends of the case body 111 to prevent the exposure of electrode leads of the battery cells and a portion of connected part between the electrode leads and busbars.

The pack housing 200 can be configured to receive the battery module 100. To this end, the pack housing 200 can have a module receiving portion S. The module receiving portion S can be an empty space shaped to receive the battery module 100 therein. Specifically, the module receiving portion S can be shaped to receive the battery module 100 therein through a partition W as described below. The pack housing 200 can comprise a material having heat resistance and high strength. In an example, the pack housing 200 can be made of a material such as metal such as steel or SUS, or plastic, or may include such material.

In the battery pack 10 of the present disclosure, an event such as thermal runaway can occur in the specific battery module 100. In this case, high temperature and high pressure venting gas can be produced in the specific battery module 100, and when the venting gas meets oxygen, flame can occur inside or outside of the battery module 100.

In this instance, the venting gas or flame can be highly likely to spread to an other battery module 100 adjacent to the specific battery module 100, and as a consequence, simultaneous thermal runaway or fires can occur in the plurality of battery modules 100. Meanwhile, the conventional battery pack includes the plurality of battery modules in the airtight pack housing and does not have a proper vent path that directs venting gas or flame out, and thus is vulnerable to multiple simultaneous fires.

To solve this problem, the pack housing 200 of the present disclosure can include an opening/closing member C. The opening/closing member C can be configured to vent the venting gas and/or flame out of the module receiving portion S in the event of thermal runaway in the battery module 100.

Specifically, the opening/closing member C can be configured to open or close the inside of the module receiving portion S according to the pressure in the module receiving portion S caused by venting gas in the event of thermal runaway of the battery module 100.

In this instance, the opening/closing member C can be rotatably coupled to one side of the module receiving portion S. In an example, the opening/closing member C can be rotatably coupled to one side of the module receiving portion S through the partition W and a coupling member I, as seen in FIG. 4. The coupling member I can be a hinge, but is not limited thereto.

By the above-described exemplary configuration of the present disclosure, it can be possible to achieve the rapid venting of venting gas and/or flame through the opening/closing member C, thereby suppressing the cause of fire in the battery module 100 and enhancing structural stability of the battery pack 10.

The coupling member I can include elastics and can be configured to control a rotational motion of the opening/closing member C. In an example, the elastics can be a torsional spring or hinge spring.

The opening/closing member C can be kept closed by the elastic force of the elastics of the coupling member I when thermal runaway does not occur in the battery module 100.

Meanwhile, when the pressure in the module receiving portion S rises above a predetermined reference pressure in the event of thermal runaway in the battery module 100, the opening/closing member C can be configured to deploy in the outward direction of the module receiving portion S to vent the venting gas and/or flame out of the module receiving portion S. The pressure in the module receiving portion S equal to or higher than the predetermined reference pressure can represent that the pressure in the module receiving portion S is higher than the external pressure of the module receiving portion S due to the produced venting gas. In this case, the compression force of air in the module receiving portion S applied to the opening/closing member C by the venting gas can be greater than the elastic force of the coupling member I that keeps the opening/closing member C closed. Accordingly, in the event of thermal runaway in the battery module 100, the opening/closing member C can easily deploy in the outward direction of the module receiving portion S by a pressure difference between the outside and inside of the module receiving portion S.

Accordingly, venting gas and/or flame can be rapidly vented through the open portion of the module receiving portion S. Additionally, when venting gas is vented, the internal pressure of the battery module 100 can drop fast.

Additionally, the opening/closing member C can be configured to close the module receiving portion S when the pressure in the module receiving portion S drops down to the reference pressure as venting gas is vented. The pressure in the module receiving portion S equal to or lower than the reference pressure can represent that the pressure in the module receiving portion S is lower than the external pressure of the module receiving portion S as venting gas is vented. In this case, not only the compression force of the outside air of the module receiving portion S applied to the opening/closing member C but also the elastic force of the coupling member I that keeps the opening/closing member C closed can be applied. Accordingly, when the pressure in the module receiving portion S decreases as venting gas is vented, the opening/closing member C can smoothly operate in the inward direction of the module receiving portion S by a pressure difference between the outside and inside of the module receiving portion S to close the module receiving portion S.

Accordingly, when venting gas emission reduces, it can be possible to effectively prevent backflow of venting gas and/or flame into the module receiving portion S by making it easy to close the module receiving portion S by the opening/closing member C. Additionally, it can be possible to suppress an additional fire in the module receiving portion S by preventing oxygen from entering the module receiving portion S.

The detailed structure of the pack housing 200 will be described in more detail below. Referring back to FIGS. 1, 2, 4 and 5, the pack housing 200 can include a side frame 210, a flow path P outside the module receiving portion S and an exit port E.

The side frame 210 can form a side of the pack housing 200, and at least a portion can be disposed facing the opening/closing member C. In this instance, the opening/closing member C can be disposed facing all the sides of the side frame 210, and can be disposed facing some of the sides of the side frame 210.

The flow path P can be disposed between the module receiving portion S and the side frame 210, and configured to communicate with the module receiving portion S through a circulation hole H formed by the opening up of the opening/closing member C in the event of thermal runaway in the battery module 100. The flow path P can provide a space for movement to allow venting gas and/or flame vented from the module receiving portion S through the circulation hole H to exit the pack housing 200.

Additionally, the opening/closing member C can be open towards the side frame 210 that it is facing, in the event of thermal runaway in the battery module 100. Additionally, the opening/closing member C can be configured to open or close the circulation hole H according to the pressure in the module receiving portion S in the event of thermal runaway in the battery module 100.

The exit port E can be disposed in the side frame 210, in communication with the flow path P and configured to allow venting gas to exit the pack housing 200. The exit port E can be formed in the shape of a hole having a predetermined area. In particular, the opening/closing member C can be open such that the end faces in the direction of flow from the circulation hole H towards the exit port E in the event of thermal runaway in the battery module 100.

By the above-described configuration, venting gas and/or flame vented from the module receiving portion S can be guided in the space between the module receiving portion S and the side of the pack housing 200 and exit the pack housing 200. Accordingly, it can be possible to allow venting gas to exit the pack housing 200 more stably.

Meanwhile, the pack housing 200 can further include a floor frame 220 and the top cover 230.

The floor frame 220 can form the bottom of the pack housing 200 and can be coupled to the side frame 210.

The top cover 230 can be coupled to the top of the side frame 210, and can air-tightly close the top of the pack housing 200. In particular, the top cover 230 can air-tightly close the top of the module receiving portion S.

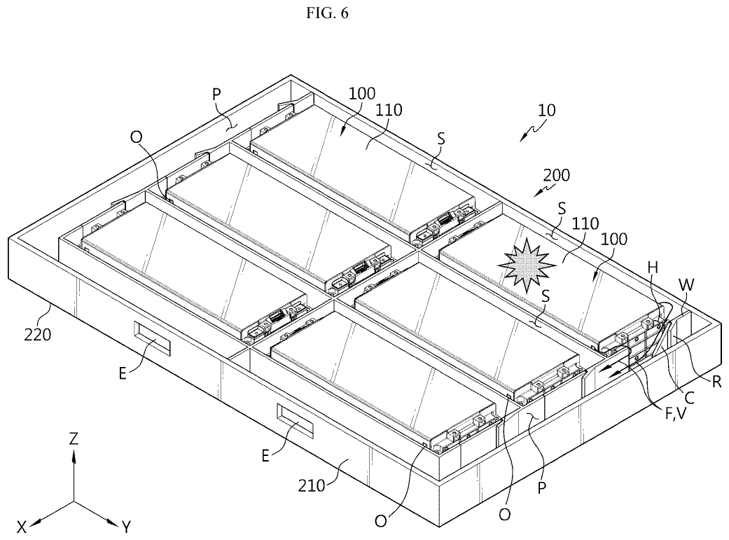

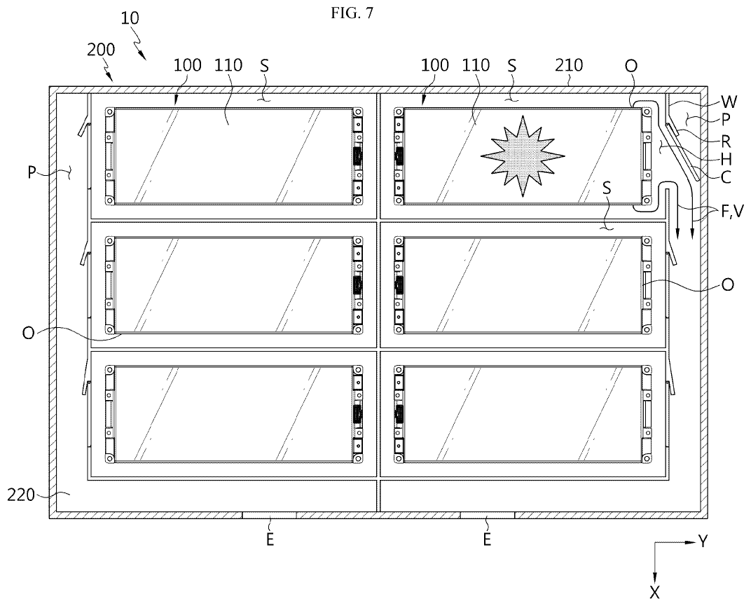

FIGS. 6 and 7 are diagrams showing an example of venting of venting gas or flame in the event of thermal runaway in the battery module 100. Specifically, FIGS. 6 and 7 show an example of thermal runaway in one battery module 100. In this instance, in FIGS. 6 and 7, venting gas and flame can be indicated by the symbols ‘V’ and ‘F’, respectively.

Referring to FIGS. 2 and 4 to 7, the opening/closing member C can be configured such that the end contacts the side frame 210 in the event of thermal runaway in the battery module 100. To this end, the length of the opening/closing member C (for example, the length extended from one side of the module receiving portion S) can be equal to or longer than a width of the flow path P (in Y axis direction) between the circulation hole H and the side frame 210.

Accordingly, when thermal runaway occurs in the battery module 100, the opening/closing member C can prevent venting gas and/or flame from entering the area opposite the exit port E on the basis of the location of contact between the end of the opening/closing member C and the side frame 210 in the flow path P. The opening/closing member C prevents venting gas and flame from moving in a direction away from the exit port. Accordingly, it can be possible to prevent venting gas and/or flame from staying in the pack housing 200, and guide the venting of venting gas and/or flame toward the exit port and out of the pack housing 200 more effectively.

Additionally, the opening/closing member C can be configured to be open at an acute angle with respect to the circulation hole H in the event of thermal runaway in the battery module 100.

Specifically, referring back to FIGS. 2, 4 to 7, a restriction member R configured to restrict the opening angle of the opening/closing member C to less than a predetermined angle can be disposed on one side of the partition wall W. The restriction member R can be a protrusion extending at an angle from the partition and have a plate shape. In particular, the restriction member R can be disposed at an acute angle with respect to the partition wall W. The angle between the restriction member R and the partition wall W can be set in an angle range between more than 0° and less than 90°.

Additionally, the restriction member R can be disposed on one side of the circulation hole H such that it is further apart from the exit port E than the opening/closing member C. Meanwhile, the restriction member R can have a shorter length (for example, the length extended from one side of the module receiving portion S) than the opening/closing member C, but is not limited thereto. Meanwhile, the angle between the restriction member R and the partition wall W can be set in a range in which the end of the opening/closing member C can contact the side frame 210 in the event of thermal runaway in the battery module 100. Accordingly, when the opening/closing member C is open towards the side frame 210 in the event of thermal runaway in the battery module 100, the opening/closing member C can come into contact with the restriction member R, thereby restricting the opening angle to less than the predetermined angle with respect to the partition wall W. Preferably, the opening/closing member C can be configured to be open at the acute angle with respect to the partition wall W by the restriction member R.

Accordingly, venting gas and/or flame vented from the module receiving portion S by thermal runaway in the battery module 100 can be vented to the flow path P along the inner surface of the opening/closing member C inclined with respect to the partition wall W. Accordingly, it can be possible to guide the flow of venting gas and/or flame towards the exit port E more effectively.

Referring back to FIGS. 2, 4 to 7, the exit port E can be formed at a location in the side frame 210 after venting gas and/or flame flowing in the flow path P bends one or more times.

That is, the exit port E can be formed at the location in the side frame 210 after the flow of venting gas and/or flame changes direction one or more times. In an example, the exit port E can be disposed at a location perpendicular to the location of the opening/closing member C in the flow path P on the basis of the corner of the side frame 210.

Accordingly, venting gas and/or flame can be vented out of the pack housing 200 at the location after the flow of venting gas and/or flame flowing in the flow path P changes direction one or more times, thereby effectively preventing backflow of venting gas and/or flame into the portion of the flow path P in which the opening/closing member C is located.

Referring to FIGS. 2, 4 and 5, a plurality of battery modules 100 can be provided, and a plurality of module receiving portions S corresponding to the plurality of battery modules 100 can be provided. In this instance, the plurality of module receiving portions S can be independent of each other.

In this instance, each of the plurality of battery modules 100 can be received in each of the plurality of module receiving portions S.

In particular, each of the plurality of module receiving portions S can be configured to be air-tightly closed by the partition W. In an example, the partition W can include a material having heat resistance and high strength.

The partition W can form a side of each module receiving portion S. Additionally, the partition W can be extended in the vertical direction corresponding to the height of the side frame 210. In this instance, the components of the partition W can be joined to each other by welding, and can be integrally formed by injection molding, but the manufacturing method is not limited thereto.

Additionally, at least a portion of the partition W can be spaced apart from the side frame 210. In an example, the flow path P can be formed at a gap between the partition W and the side frame 210.

Additionally, the floor frame 220 can be coupled to the bottom of the partition W, and the top cover 230 can be coupled to the top of the partition W. Meanwhile, in the battery pack 10 of the present disclosure, the top cover 230 can cover up the side frame 210 and the top of the partition W.

By the above-described configuration, it can be possible to suppress multiple simultaneous fires between the adjacent battery modules 100 when thermal runaway occurs in the specific battery module 100.

In particular, the partition W can have an opening/closing member C corresponding to each module receiving portion S.

Specifically, the opening/closing member C can be rotatably coupled to one side of the partition W. In this instance, the opening/closing member C can be rotatably coupled to the partition W through the coupling member I. Additionally, the restriction member R can be disposed on one side of the partition W and configured to restrict the opening angle of the opening/closing member C to less than the predetermined angle.

Each opening/closing member C disposed in the partition W, corresponding to each module receiving portion S, can be configured to open or close the circulation hole H according to the pressure in each module receiving portion S in the event of thermal runaway in the battery module 100.

Meanwhile, as shown in FIGS. 2 and 3, the battery module 100 of the present disclosure can have a venting hole O in at least one surface of the module case 110 to vent the venting gas and/or flame. In an example, the venting hole O can be disposed in a top surface of the module case 110. However, as shown in FIGS. 2 and 3, the venting hole O can be disposed in two side surfaces of the module case 110. Here, the two side surfaces can be opposite surfaces along the X axis, and the venting hole O can be extended along the Z axis. Additionally, the plurality of battery modules 100 can be received in each module receiving portion S such that the venting hole O is disposed close to the opening/closing member C.

When thermal runaway occurs in in the battery module 100, venting gas and/or flame generated in the battery module 100 can be directionally vented towards the two sides of the battery module 100 through the venting hole O. Additionally, venting gas and/or flame vented through the venting hole O can be rapidly vented to the flow path P through the circulation hole H via the space between the battery module 100 and the partition W in the module receiving portion S or the space between the battery module 100 and the side frame 210.

Accordingly, by the above-described exemplary configuration of the present disclosure, when simultaneously thermal runaway occurs in the plurality of battery modules 100, venting gas and/or flame vented through the venting hole O in the two side surfaces of the battery module 100 can be guided towards the flow path P and vented out of the pack housing 200 more rapidly.

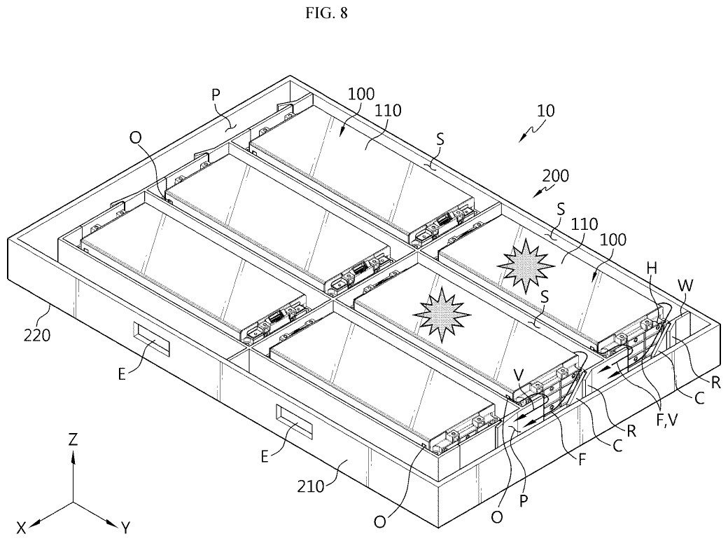

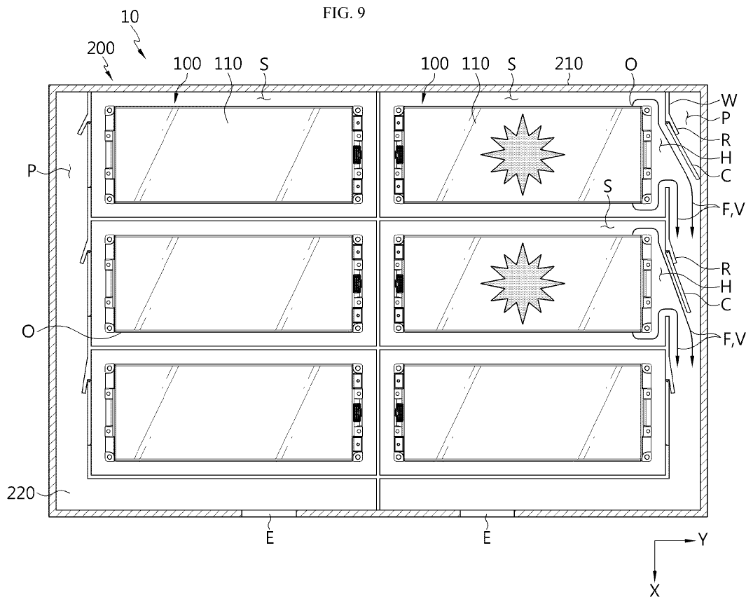

FIGS. 8 and 9 are diagrams showing another example of venting of venting gas or flame in the event of thermal runaway in the battery module 100. Specifically, FIGS. 8 and 9 show an example of thermal runaway in the plurality of battery modules 100. In this instance, in FIGS. 8 and 9, venting gas and flame can be indicated by the symbols ‘V’ and ‘F’, respectively.

Referring to FIGS. 2, 4, 8 and 9, at least some of the opening/closing members C can be configured to be open towards the side frame 210 to a lesser extent toward the exit port E in the event of thermal runaway in the plurality of battery modules 100.

As described above, each opening/closing member C can be configured to be open at an acute angle with respect to the partition W in the event of thermal runaway in the plurality of battery modules 100.

Additionally, at least some of the opening/closing members C can be configured to reduce the opening angle toward the exit port E.

Specifically, the restriction member R configured to restrict the opening angle of the opening/closing member C to less than the predetermined angle can be disposed on one side of the module receiving portion S for each opening/closing member C. The restriction member R can be disposed at an acute angle with respect to the partition W.

In particular, at least some of the restriction members R can be configured to reduce the angle with respect to the partition W toward the exit port E. Accordingly, at least some of the opening/closing members C can be configured to reduce the opening angle toward the exit port E.

In an aspect, each opening/closing member C can be configured to reduce the opening angle toward the exit port E. In this instance, the restriction member R disposed for each opening/closing member C can be configured to reduce the angle with respect to the partition W toward the exit port E. In this case, venting gas and/or flame vented to the flow path P through the opening of the specific opening/closing member C can be allowed to smoothly flow toward the exit port E without being restricted by the outer surface of the other opening/closing member C located closer to the exit port E than the specific opening/closing member C.

That is, as the opening/closing member C is located further away from the exit port E, venting gas and/or flame can be vented to the flow path P along the inner surface of the opening/closing member C so as to be guided in a direction close to the side frame 210. Accordingly, it can be possible to minimize the likelihood that venting gas and/or flame vented to the flow path P through the opening of the specific opening/closing member C can hit the outer surface of the other opening/closing member C located closer to the exit port E than the specific opening/closing member C. Additionally, since the likelihood that venting gas and/or flame vented to the flow path P through the opening up of the specific opening/closing member C hits the outer surface of the other opening/closing member C is minimized, it can be possible to minimize the flow (backflow) of venting gas and/or flame vented to the flow path P back into the module receiving portion S.

By the above-described exemplary configuration of the present disclosure, when simultaneously thermal runaway occurs in the plurality of battery modules 100, venting gas and/or flame vented from the inside of each module receiving portion S can be vented to the flow path P along the inner surface of the opening/closing member C inclined with respect to the partition W. Accordingly, the flows of venting gas and/or flame can be stably guided towards the exit port E.

Additionally, when simultaneously thermal runaway occurs in the plurality of battery modules 100, it can be possible to prevent restriction of the flows of venting gas and/or flame vented to the flow path P through the opening of each opening/closing member C towards the exit port E, and effectively prevent backflow of venting gas and/or flame into the plurality of module receiving portions S.

Referring back to FIGS. 2, 4, 8 and 9, the opening/closing member C located furthest away from the exit port E can be configured such that the end contacts the side frame 210 in the event of thermal runaway in the plurality of battery modules 100. To this end, the length (for example, the length extended from one side of the module receiving portion S) of the opening/closing member C located furthest away from the exit port E can be equal to or longer than the length (in Y axis direction) between the circulation hole H and the side frame 210. Meanwhile, the angle between the partition W and the restriction member R that restricts the opening angle of the opening/closing member C located furthest away from the exit port E can be set in the range in which the end of the opening/closing member C located furthest away from the exit port E can contact the side frame 210 in the event of thermal runaway in the battery module 100.

Accordingly, when thermal runaway simultaneously occurs in the plurality of battery modules 100, the opening/closing member C located furthest away from the exit port E can prevent venting gas and/or flame from entering the area opposite the exit port E on the basis of the location of contact between the end of the corresponding opening/closing member C and the side frame 210 in the flow path P. Accordingly, when thermal runaway occurs in the plurality of battery modules 100, it can be possible to prevent venting gas and/or flame from staying in the pack housing 200 and guide the venting of the venting gas and/or flame out of the pack housing 200 more effectively.

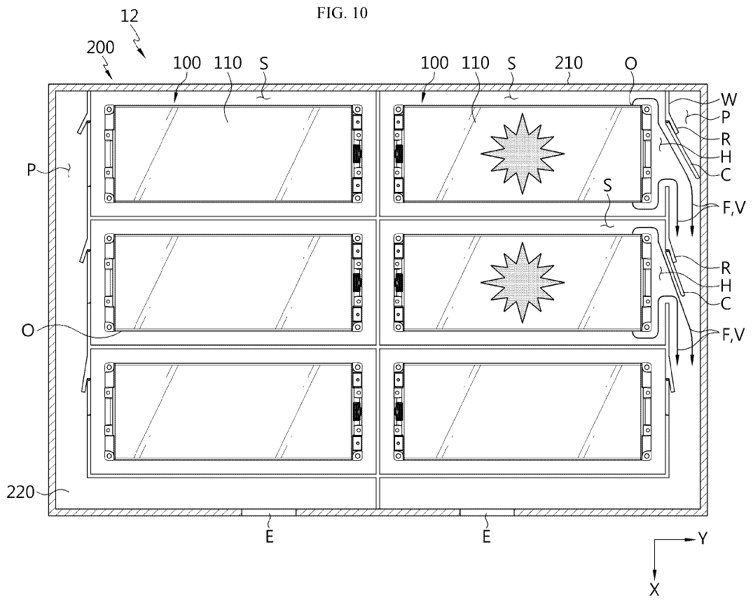

FIG. 10 is a diagram showing a battery pack 12 according to a second aspect of the present disclosure.

The battery pack 12 according to this aspect is similar to the battery pack 10 of the previous aspect, and in the description of the components that are substantially identical or similar to those of the previous aspect, redundant description is omitted, and differences between this aspect and the previous aspect will be described below. In this instance, in FIG. 10, venting gas and flame are indicated by the symbols ‘V’ and ‘F’, respectively.

As described above, each opening/closing member C can be configured to be open at an acute angle with respect to the circulation hole H in the event of thermal runaway in the plurality of battery modules 100. This can be accomplished by the restriction member R.

Referring to FIG. 10, in the battery pack 12 according to this aspect, at least some of the opening/closing members C can be configured to reduce the length toward the exit port E in the event of thermal runaway in the plurality of battery modules 100. In this instance, each circulation hole H can be sized to conform to the size of each opening/closing member C.

In an aspect, each opening/closing member C can be configured to reduce the length toward the exit port E. In this case, venting gas and/or flame vented to the flow path P through the opening of the specific opening/closing member C can be allowed to smoothly flow towards the exit port E without being restricted by the outer surface of the other opening/closing member C located closer to the exit port E than the specific opening/closing member C.

That is, as the opening/closing member C is located further away from the exit port E, venting gas and/or flame can be vented to the flow path P along the inner surface of the opening/closing member C so as to be guided in a direction close to the side frame 210. Accordingly, it can be possible to minimize the likelihood that venting gas and/or flame vented to the flow path P through the opening of the specific opening/closing member C hits the outer surface of the other opening/closing member C located closer to the exit port E than the specific opening/closing member C. Additionally, since the likelihood that venting gas and/or flame vented to the flow path P through the opening of the specific opening/closing member C hits the outer surface of the other opening/closing member C is minimized, it can be possible to minimize the flow (backflow) of venting gas and/or flame vented to the flow path P back into the module receiving portion S.

By the battery pack 12 according to this aspect, when simultaneously thermal runaway occurs in the plurality of battery modules 100, it can be possible to prevent restriction of the flows of venting gas and/or flame vented to the flow path P through the opening of each opening/closing member C towards the exit port E, and effectively prevent backflow of venting gas and/or flame into the plurality of module receiving portions S.

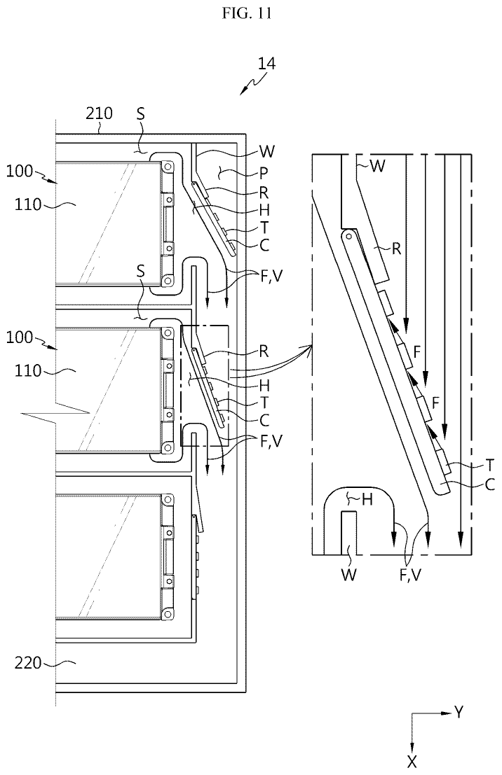

FIG. 11 is a diagram showing a battery pack 14 according to a third aspect of the present disclosure.

The battery pack 14 according to this aspect is similar to the battery pack 10 of the previous aspect, and in the description of the components that are substantially identical or similar to those of the previous aspect, redundant description is omitted, and differences between this aspect and the previous aspect will be described below. In this instance, in FIG. 11, venting gas and flame are indicated by the symbols ‘V’ and ‘F’, respectively.

Referring to FIG. 11, the battery pack 14 can further include an interrupt member T.

The interrupt member T can be disposed on a surface (an outer surface) of each opening/closing member C facing the outside of the module receiving portion S. The interrupt member T can interrupt flame (or sparks) occurring in the event of thermal runaway in the battery module 100. In an example, a plurality of interrupt members T can be formed in the shape of protrusions on the outer surface of the opening/closing member C.

When the plurality of interrupt members T is formed on the outer surface of the opening/closing member C, a portion of flame vented to the flow path P through the opening up of the specific opening/closing member C can hit the interrupt member T formed on the outer surface of the other opening/closing member C located closer to the exit port E than the specific opening/closing member C and stay on the outer surface of the opening/closing member C. Accordingly, it can be possible to minimize the exposure of flame through the pack housing 200.

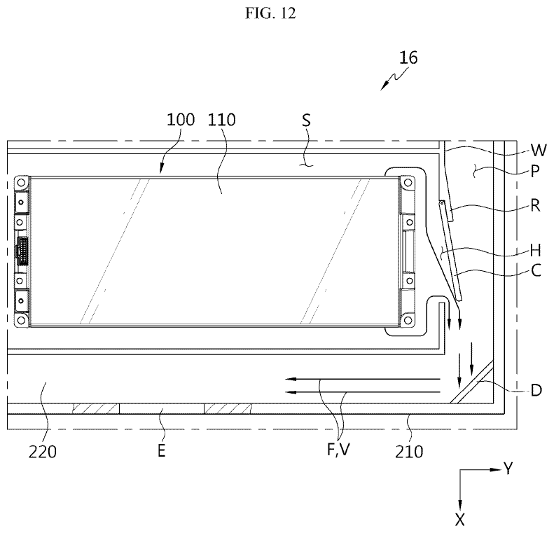

FIG. 12 is a diagram showing a battery pack 16 according to a fourth aspect of the present disclosure.

The battery pack 16 according to this aspect is similar to the battery pack 10 of the previous aspect, and in the description of the components that are substantially identical or similar to those of the previous aspect, redundant description is omitted, and differences between this aspect and the previous aspect will be described below.

Referring to FIG. 12, the battery pack 16 can further include a guide member D.

The guide member D maybe disposed at a portion of the flow path P located at the corner of the side frame 210, and can be configured to guide venting gas and/or flame towards the exit port E. In an example, the guide member D can include a material having heat resistance and high strength. In an example, the guide member D can be made of a material such as metal such as steel or SUS, or plastic, or may include such material.

The guide member D can have one end coupled to the portion of the side frame 210 facing the opening/closing member C. Additionally, the guide member G D can have the other end coupled to the portion of the side frame 210 in which the exit port E is located. Additionally, the guide member G D can be inclined from the portion of the side frame 210 facing the opening/closing member C to the portion of the side frame 210 in which the exit port E is located.

By the above-described exemplary configuration, the flow of venting gas and/or flame flowing in the flow path P can be smoothly guided towards the exit port E. Additionally, since the flow of venting gas and/or flame changes through the guide member D inclined towards the exit port E, it can be possible to prevent backflow of venting gas and/or flame into the portion of the flow path P in which the opening/closing member C is located.

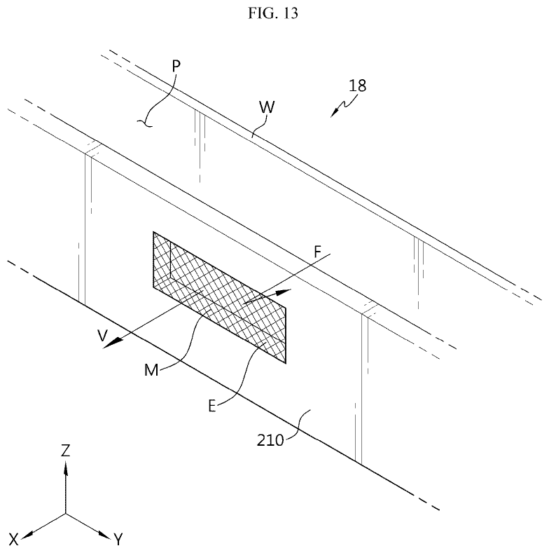

FIG. 13 is a diagram showing a battery pack 18 according to a fifth aspect of the present disclosure.

The battery pack 18 according to this aspect is similar to the battery pack 10 of the previous aspect, and in the description of the components that are substantially identical or similar to those of the previous aspect, redundant description is omitted, and differences between this aspect and the previous aspect will be described below.

Referring to FIG. 13, the battery pack 18 can further include a mesh member M.

The mesh member M can be disposed in the exit port E and configured to filter out flame and allow venting gas to pass through. The mesh member M can be in the shape of a plate member having pores, or a mesh formed by weaving a plurality of wires. In this instance, the pores can have a sufficient size to filter out flame vented out of the pack housing 200 from the flow path P. That is, the mesh member M can prevent flame from being vented out of the pack housing 200 and causing a fire.

By the battery pack 18 according to this aspect, it is possible to suppress the passage of flame and allow venting gas to pass through the mesh structure formed in the exit port E. Accordingly, it can be possible to minimize the exposure of flame through the pack housing 200 and achieve rapid venting of venting gas.

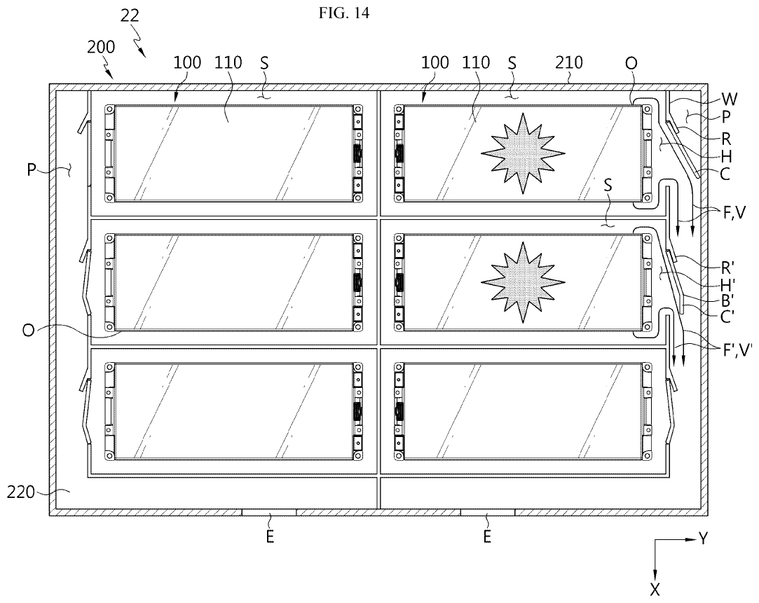

FIG. 14 is a diagram showing a battery pack 20 according to another aspect of the present disclosure.

Referring to FIG. 14, in the battery pack 20 according to this aspect, each opening/closing member C can further include a bending portion B formed by bending a portion of the opening/closing member C. The bending portion B can bend from the opening/closing member C in the outward direction of the module receiving portion S. The bending portion B can be at an obtuse angle to prevent restriction of the movement of venting gas and/or flame vented through the circulation hole H. Additionally, unlike FIG. 14, the bending portion B can be curved.

In this instance, as shown in FIG. 14, as the opening/closing member C is located further away from the exit port E, the angle formed by the bending portion B can be greater. For example, the opening/closing member C located furthest away from the exit port E can be at 180° or an angle approximately close to 180° and can contact the side frame 210. In contrast, bending portion B of the opening/closing member C′ located close to the exit port E can be bent at a smaller angle, for example, 120°.

Accordingly, the bending portion B′ can minimize the likelihood that the flow of venting gas and/or flame F, V vented to the flow path P through the opening up of the opening/closing member C located further away from the exit port E than the specific opening/closing member C′ towards the exit port E hits the outer surface of the specific opening/closing member C′, thereby preventing obstruction of the other flow of gas or flame vented to the flow path P in the rear side. Additionally, it can be possible to minimize the flow (backflow) of venting gas and/or flame F, V vented to the flow path P through the opening of the opening/closing member C located further away from the exit port E than the specific opening/closing member C′ back into the module receiving portion S due to being blocked by the opening/closing member C′ bent towards the open circulation hole H′.

Additionally, by the above-described exemplary configuration, when venting gas or flame F′, V′ is vented through the circulation hole H′, venting gas or flame F′, V′ can be vented to the flow path P more smoothly through the bent shape of the opening/closing member C′. That is, by the above-described exemplary configuration, when the opening/closing member C′ is open, the bent end can be approximately parallel to the flow direction of the flow path P and the side frame 210. Accordingly, flame F′, V′ or the like vented to the corresponding opening/closing member C′ can be smoothly vented and flow along the flow direction of the flow path P as indicated in FIG. 14.

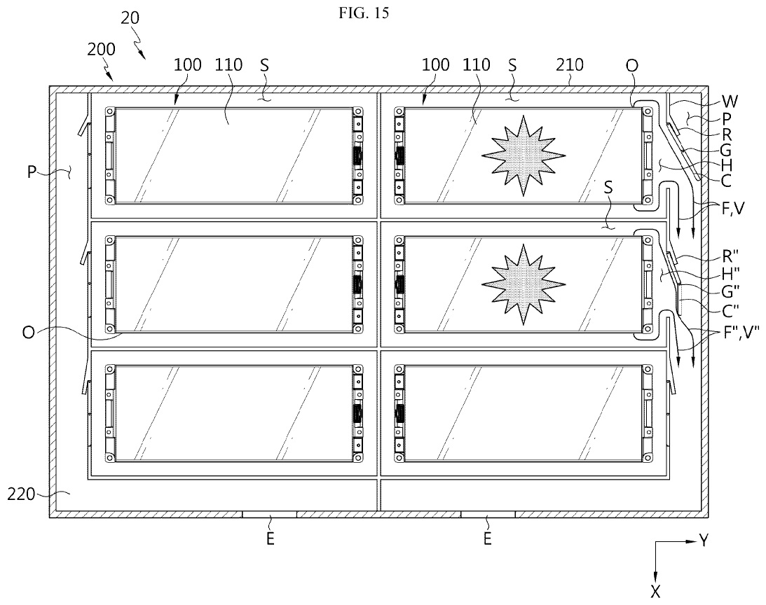

FIG. 15 is a diagram showing a battery pack 22 according to another aspect of the present disclosure.

Referring to FIG. 15, in the battery pack 22 according to this aspect, each opening/closing member C can further include a hinge portion G to rotate a portion of the opening/closing member C. The hinge portion G can be disposed in a predetermined portion of the opening/closing member C, especially, at the center. Additionally, the hinge portion G can be configured to form an obtuse angle between two sides to prevent restriction of the movement of venting gas and/or flame vented through the circulation hole H. Further, the opening/closing member C can be unfolded such that the angle between the two sides of the hinge portion G is up to 180°.

In particular, the hinge portion G can be configured such that the angle between two sides is 180° when there is no external pressure applied. That is, the opening/closing member C can be formed in a plate shape, in other words, such that the angle of the hinge portion G is 180° in a state that there is no external force applied or a predetermined level or less of force is applied. To this end, the hinge portion G can include elastics such as a spring. In the above-described exemplary configuration, when thermal runaway does not occur in the battery module 100, the opening/closing member C is not rotated by the hinge portion G and can be maintained at 180° and kept closed.

As shown in FIG. 15, when thermal runaway occurs in the plurality of battery modules 100, the specific opening/closing member C″, for example, the opening/closing member located at the center in the front-rear direction (X axis direction) can open the module receiving portion S for which it takes responsibility when the internal pressure of the module receiving portion S rises. In this instance, the opening/closing member C″ can be bent by gas and/or flame F, V vented from the other module receiving portion S. For example, in the aspect of FIG. 15, the end of the opening/closing member C″ can be rotated towards the circulation hole H″ by the force of venting gas and/or flame F, V vented from the rear side (−X axis direction) to the flow path P.

By the above-described exemplary configuration, it can be possible to minimize the likelihood that venting gas and/or flame F, V vented to the flow path P through the opening up of the opening/closing member C located further away from the exit port E than the specific opening/closing member C″ hits the outer surface of the other opening/closing member C″, thereby achieving more smooth movement of gas and/or flame F, V in the flow path P. Additionally, in this case, it can be possible to minimize backflow of venting gas and/or flame F, V vented to the flow path P into the other module receiving portion S.

Meanwhile, in the same way as the specific opening/closing member C″, the opening/closing member C located further away from the exit port E than the specific opening/closing member C″ can be provided by the rotation of the hinge portion G towards the circulation hole H. In this instance, as the opening/closing member C is located closer to the exit port E, an angle at which the end portion rotates towards the circulation hole H can be higher. For example, since the opening/closing member C located furthest away from the exit port E does not have the force applied from the outer surface of the opening/closing member C, and only has the force applied on the inner surface due to venting gas and/or flame F, V vented to the circulation hole H, the hinge portion G is not rotated and can be kept at 180° and contact the side frame 210. In contrast, the opening/closing member C″ located closer to the exit port E can be configured such that the end rotates towards the circulation hole H″ to provide a space for flow of gas (F, V) vented in the rear side. For example, when the hinge portion G includes elastics, the opening/closing member C″ located close to the exit port E can include elastics having lower elastic modulus than the opening/closing member C located further away from the exit port E.

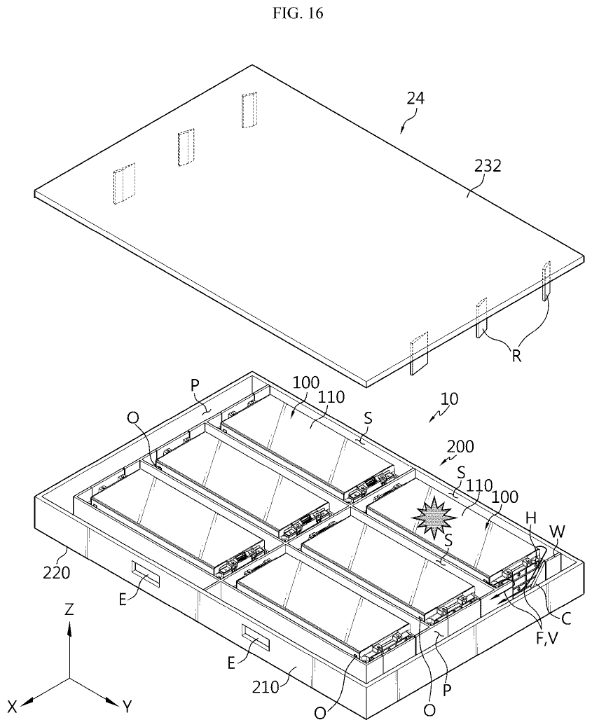

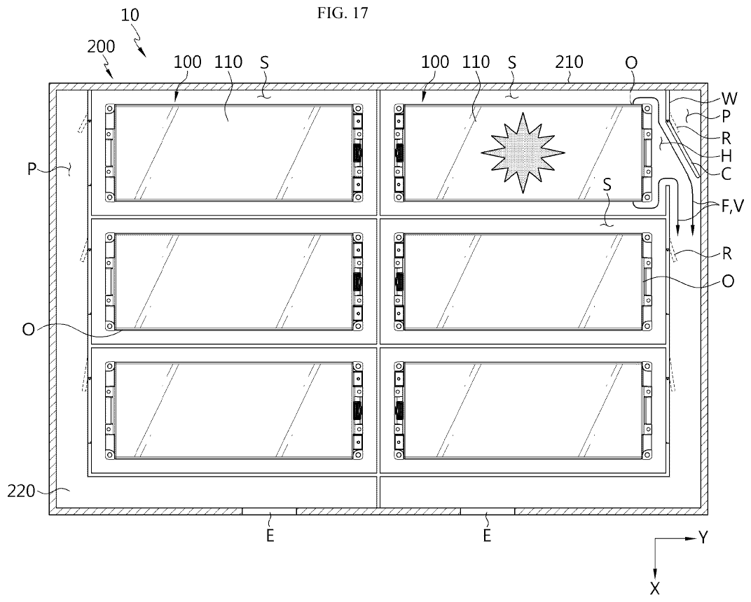

By the battery pack 22 according to this aspect, when simultaneously thermal runaway occurs in the plurality of battery modules 100, it can be possible to prevent restriction of the flows of venting gas and/or flame vented to the flow path P toward the exit port E through the opening up of each opening/closing member C towards the exit port E, and effectively prevent backflow of venting gas and/or flame into the plurality of module receiving portions S. FIGS. 16 and 17 are diagrams showing a battery pack 24 according to another aspect of the present disclosure. FIG. 16 is an exploded perspective view of the battery pack 24, and FIG. 17 is a diagram showing the battery pack 24 with a top cover 232 coupled thereto when viewed from the top.

Referring to FIGS. 16 and 17, unlike the above-described aspects in which the restriction member R is coupled to one side of the partition W, the battery pack 24 can include the restriction member R incorporated into the top cover 230.

That is, the top cover 232 according to this aspect can include the restriction member R that protrudes from at least one surface of the top cover 232 to restrict the opening angle of the opening/closing member C to less than the predetermined angle. The top cover 232 can be in the shape of a rectangular plate coupled to the top of the partition W and configured to simultaneously cover the side frame 210 and the partition W.

Accordingly, the partition W formed on top of the floor frame 220 is structurally simplified, which makes the fabrication process easy and reduces the cost. Additionally, when the top cover 232 is assembled with the floor frame 220, the restriction member R guides the assembly location, thereby enhancing the assembly efficiency, and one end of the restriction member R is supported on the partition W, so it can be possible to prevent the top cover 232 from moving in the horizontal direction (X axis or Y axis direction) and the vertical direction (Z axis direction), thereby enhancing the coupling strength between the top cover 232 and the floor frame 220.

Meanwhile, the height of the restriction member R of the top cover 232 can be equal to or smaller than the height of the partition W or the side frame 210. In an aspect, when the height of the restriction member R is equal to the height of the partition W or the side frame 210, unlike the above-described aspects in which the top cover 230 is coupled to the side frame 210 and the top end of the partition W, the top cover 230 can be directly coupled to not only the side frame 210 and the partition W but also the floor frame 220 by the restriction member R. That is, the restriction member R can be coupled to one side of the partition W to which the opening/closing member C is coupled and can be coupled with the lower end in contact with the floor frame 220. By the above-described configuration, when a vertical compression force is applied to the battery pack 24 or vertical bending impact is applied to the battery pack 24, it can be possible to ensure strength or stability without any pack reinforcement.

Accordingly, in the event of thermal runaway in the plurality of battery modules 100, the battery pack 20 according to this aspect can prevent venting gas and/or flame from staying in the pack housing 200, and guide the venting of venting gas and/or flame out of the pack housing 200 more effectively, and ensure coupling stability of the battery pack 24 by the restriction member R of the top cover 232 coupled to the partition W and the floor frame 220.

As described above, according to an aspect of the present disclosure, it can be possible to achieve the rapid venting of venting gas and/or flame through the opening/closing member C, thereby suppressing the causes of fires in the battery module 100 and enhancing structural stability of the battery pack 10, 12, 14, 16, 18, 20, 22, 24.

Additionally, it can be possible to prevent venting gas and/or flame from staying in the pack housing 200 and guide the venting of venting gas and/or flame out of the pack housing 200 more effectively.

Additionally, when simultaneously thermal runaway occurs in the plurality of battery modules 100, it can be possible to prevent restriction of the flows of venting gas and/or flame vented to the flow path P through opening up of each opening/closing member C towards the exit port E, and effectively prevent backflow of venting gas and/or flame into the plurality of module receiving portions S.

Meanwhile, in addition to the above-described configuration, the battery pack 10, 12, 14, 16, 18, 20, 22, 24 according to the present disclosure can further include devices for controlling the charge/discharge of the battery pack 10, 12, 14, 16, 18, 20, 22, 24, for example, a Battery Management System (BMS), a current sensor and a fuse.

Additionally, the battery pack 10, 12, 14, 16, 18, 20, 22, 24 according to the present disclosure can be applied to a vehicle such as an electric vehicle. That is, the vehicle according to the present disclosure can include at least one battery pack 10, 12, 14, 16, 18, 20, 22, 24 according to the present disclosure.

While the present disclosure has been hereinabove described with regard to aspects and drawings, the present disclosure is not limited thereto and it is apparent that a variety of changes and modifications can be made by those skilled in the art within the technical aspect of the present disclosure and the scope of the appended claims and their equivalents.

What is claimed is:

1. A battery pack, comprising:
at least one battery module; and
a pack housing accommodating the at least one battery module in at least one module receiving portion, the at least one module receiving portion including an opening/closing member configured to vent a venting gas or flame out of the at least one module receiving portion in an event of thermal runaway in the at least one battery module.

2. The battery pack according to claim 1, wherein the pack housing includes:
a side frame which forms a side of the pack housing, and at least a portion of the side frame facing the opening/closing member;
a flow path between the at least one module receiving portion and the side frame, and formed in communication with the at least one module receiving portion through a circulation hole formed in the at least one module receiving portion; and
an exit port disposed in the side frame, the exit port communicating with the flow path and configured to vent the venting gas or flame out of the pack housing.

3. The battery pack according to claim 2, wherein the opening/closing member is configured such that a first end contacts the side frame when opened.

4. The battery pack according to claim 2, wherein the opening/closing member is configured to be open at an acute angle with respect to a partition of the at least one module receiving portion.

5. The battery pack according to claim 2, wherein the exit port is formed at a location in the side frame relative to the opening/closing member so that the flow path bends one or more times.

6. The battery pack according to claim 2, wherein the at least one battery module is a plurality of the battery modules, and the at least one battery module receiving portion is a plurality of the module receiving portions,
wherein each of the plurality of the battery modules is received in a respective one of the plurality of module receiving portions, and
wherein each of the plurality of module receiving portions is configured to be air-tightly closed by a partition.

7. The battery pack according to claim 6, wherein each opening/closing member corresponding to each module receiving portion of the plurality of module receiving portions is disposed in the partition.

8. The battery pack according to claim 7, wherein each opening/closing member is configured to be open at an acute angle with respect to the partition, and wherein at least one opening/closing member is configured to reduce an opening angle toward the exit port.

9. The battery pack according to claim 7, wherein an opening/closing member located furthest away from the exit port is configured such that a first end contacts the side frame when opened.

10. The battery pack according to claim 7, wherein at least one of the opening/closing members has a shorter length than another opening/closing member further from the exit port.

11. The battery pack according to claim 7, wherein an interrupt member configured to prevent the flame is disposed on an outer surface of each opening/closing member.

12. The battery pack according to claim 2, further comprising:
a guide member disposed at a corner of the side frame, and configured to guide the venting gas or flame towards the exit port.

13. The battery pack according to claim 2, further comprising:
a mesh member disposed in the exit port, and configured to filter out the flame and allow the venting gas to pass through.

14. A vehicle comprising at least one battery pack according to claim 1.

15. A pack housing, comprising:
a side frame forming an exterior surface;
a partition in the side frame, the partition forming at least one battery module receiving area and a first flow path between the partition and a first side of the side frame;
at least one circulation hole formed in the partition allowing communication between the at least one battery module receiving area and the first flow path;
at least one opening/closing member covering the at least one circulation hole; and
a first exit port in the side frame.

16. The pack housing of claim 15, wherein the first exit port is in a second side of the side frame.

17. The pack housing of claim 15, further comprising a second flow path between the partition and a third side of the side frame,
wherein the partition extends across the side frame from a second side of the side frame to a fourth side of the side frame to separate the first flow path from the second flow path, and
wherein the second flow path has a second exit port.

18. The pack housing of claim 15, wherein the at least one battery module receiving area is a plurality of battery module receiving areas formed by the partition,
wherein the at least one circulation hole is a plurality of circulation holes respectively formed in the plurality of battery module receiving areas, and
wherein the at least opening/closing member is a plurality of opening/closing members respectively covering each of the plurality of circulation holes.

19. The pack housing of claim 15, further comprising a protrusion extending from the partition, the protrusion restricting an opening angle of the at least one opening/closing member.

20. The pack housing of claim 15, wherein the at least one opening/closing member comprises a first opening/closing member and a second opening/closing member, the first opening/closing member being further from the first exit port than the second opening/closing member, and
wherein the first opening/closing member contacts the first side of the side frame when fully opened and the second opening/closing member is spaced from the first side of the side frame when fully opened.
